(19) United States
(12) Patent Application Publication
(10) Pub. No.: US 2012/0126617 A1
(43) Pub. Date: May 24, 2012

(54) INDUSTRIAL COMPUTER SET, POWER CABINET AND SYSTEM CABINET

(75) Inventor: Sing-Hao PENG, TAIPEI CITY (TW)

(73) Assignee: INVENTEC CORPORATION, TAIPEI CITY (TW)

(21) Appl. No.: 13/074,027

(22) Filed: Mar. 29, 2011

(30) Foreign Application Priority Data
Nov. 19, 2010 (TW) 099140009

(51) Int. Cl. H02J 1/00

(52) U.S. Cl. 307/42

(57) ABSTRACT

An industrial computer set is provided and includes a power cabinet and a plurality of system cabinets. The power cabinet includes a power conversion module and a power cable distribution tray. The power conversion module is coupled between mains electricity and the power cable distribution tray. The power conversion module is used for converting a high-voltage AC power into a high-voltage DC power. Each of the system cabinets includes a plurality of system units and a shunt module. The shunt module is coupled between the power cable distribution tray and the system units. The shunt module receives the high-voltage AC power from the power cable distribution tray, and shunts the high-voltage AC power to the system units.

### RELATED APPLICATIONS

This application claims priority to Taiwan Application Serial Number 099140009, filed Nov. 19, 2010, which is herein incorporated by reference.

### BACKGROUND

1. Field of Invention

The invention relates to a power supply mechanism, and more particularly, to a power supply of an industrial computer set.

2. Description of Related Art

With the daily advance of computer industry, enterprises more and more rely on industrial computer systems. An industrial computer generally refers to a non-personal computer or a non-consumer electronic system. For example, the industrial computer includes core control equipment used for factory automation, a web server, an enterprise data backup server and so on.

With the development of electronic technologies and applications related to the industrial computer, industrial requirements for a server system are increased accordingly. To cope with the development of the enterprises, many enterprises generally integrate a large number of server units into a computer cabinet, and may use many groups of computer cabinets to form a industrial computer set so as to meet the demands of a large amount of data produced or high network flows, for example, and meanwhile to meet requirements of subsequent expansion and upgrade of the server system.

In general, an industrial computer set may include multiple system cabinets, and each of the system cabinets further includes multiple single-board computer units (such as blade computers). If each of the respective single-board computer units in the industrial computer set has disposed its power supply and power line, a large space will be occupied and system maintenance will be difficult to be performed. Moreover, the installation of many power supplies requires many transformers and coils, thus causing increased fabrication cost, resource waste and decreased power use efficiency.

For example, an input power source of respective server unit, storage unit and network unit in a conventional data center is generally an AC voltage source from an electric power company. However, internal working circuits of the respective server unit, storage unit and network unit require a stable DC power source. Thus, each of the aforementioned units has its own power supply disposed therein, and the power supply may include a transformer and an AC-to-DC converter. The power supply can in charge of converting an AC power source of 110V or 220V into a DC power source of 12V output voltage, so as to meet the power source requirements of each unit. Since the conventional data center may have up to hundreds or thousands of system units for computation, storage and communication, the independent power supplies disposed in the respective system units will consume a lot of fabrication resource and cost.

### SUMMARY

In order to solve the aforementioned problems, the present invention provides an industrial computer set, which has an independent power cabinet for supplying power to multiple system cabinets. Furthermore, the industrial computer set uses the power cabinet to directly convert a high-voltage AC power inputted from mains electricity into a high-voltage DC power and to transfer the high-voltage DC power respectively to each system cabinet. Each system cabinet only needs to divide or adjust a voltage of the DC power so as to transfer the DC power respectively to each system unit for use.

Therefore, an aspect of the invention is to provide an industrial computer set including a power cabinet and a plurality of system cabinets. The power cabinet includes a power conversion module and a power cable distribution tray. The power conversion module is coupled between mains electricity and the power cable distribution tray. The power conversion module is used for converting a high-voltage AC power into a high-voltage DC power. Each of the system cabinets includes a plurality of system units and a shunt module. The shunt module is coupled between the power cable distribution tray and the system units. The shunt module is used for receiving the high-voltage DC power from the power cable distribution tray, and shunting the high-voltage DC power to the system units.

According to an embodiment of the invention, the shunt module includes a power junction box and n pieces of power distribution units, and each of the system cabinets includes n*m pieces of system units, wherein the power junction box is used for shunting the high-voltage AC power to the power distribution units, and each of the power distribution units is used for shunting the high-voltage AC power to m pieces of system units.

According to another embodiment of the invention, each system unit includes a transformer and an internal circuit. The transformer is coupled with the shunt module, and the transformer is used for converting the high-voltage DC power into a low-voltage DC power for driving the internal circuit.

According to yet another embodiment of the invention, the mains electricity is used for providing the high-voltage AC power, and the high-voltage AC power is an AC power of more than 300V. In addition, the high-voltage DC power is a DC power of more than 300V.

Another aspect of the invention is to provide a power cabinet, which is used for being coupled to a plurality of system cabinets. Each of the system cabinets includes a plurality of system units and a shunt module, and the shunt module is coupled to the system units. The power cabinet includes a power conversion module and a power cable distribution tray. The power conversion module is coupled between mains electricity and the power cable distribution tray, and the power conversion module is used for converting a high-voltage AC power into a high-voltage DC power. The power cable distribution tray is used for shunting the high-voltage DC power to the shunt module in the system cabinets.

According to an embodiment of the invention, the mains electricity is used for providing the high-voltage AC power which is an AC power of more than 300V. In addition, the high-voltage DC power is a DC power of more than 300V.

Another aspect of the invention is to provide a system cabinet, which is coupled with a power cabinet, wherein the power cabinet includes a power conversion module and a power cable distribution tray. The power conversion module is coupled between mains electricity and the power cable distribution tray, and the power conversion module is used for converting a high-voltage AC power into a high-voltage DC power. The power cable distribution tray is used for transmitting the high-voltage DC power to the system cabinet. The system cabinet includes a plurality of system units and a shunt module. Each of the system unit includes an internal circuit and a transformer. The shunt module is icy coupled between the power cable distribution tray and the system units. The shunt module is sued for receiving the high-voltage DC power from the power cable distribution tray, and shunting the high-voltage DC power to the system units, wherein the transformer in each of the system units is coupled with the shunt module, and the transformer is used for converting the high-voltage DC power into a low-voltage DC power for driving the internal circuit.

According to an embodiment of the invention, the shunt module includes a power junction box and n pieces of power distribution units, and each of the system cabinets includes n*m pieces of system units, wherein the power junction box is used for shunting the high-voltage AC power to the power distribution units, and each of the power distribution unit is used for shunting the high-voltage AC power to m pieces of system units.

It is to be understood that both the foregoing general description and the following detailed description are by examples, and are intended to provide further explanation of the invention as claimed.

### BRIEF DESCRIPTION OF THE DRAWINGS

In order to make the foregoing as well as other aspects, features, advantages, and embodiments of the invention more apparent, the accompanying drawings are described as follows:

FIG. 1 is a schematic view of an industrial computer set according to an embodiment of the invention;

FIG. 2 is a schematic view of a shunt module in FIG. 1; and

FIG. 3 is an internal schematic view of a system unit according to an embodiment of the invention.

### DETAILED DESCRIPTION

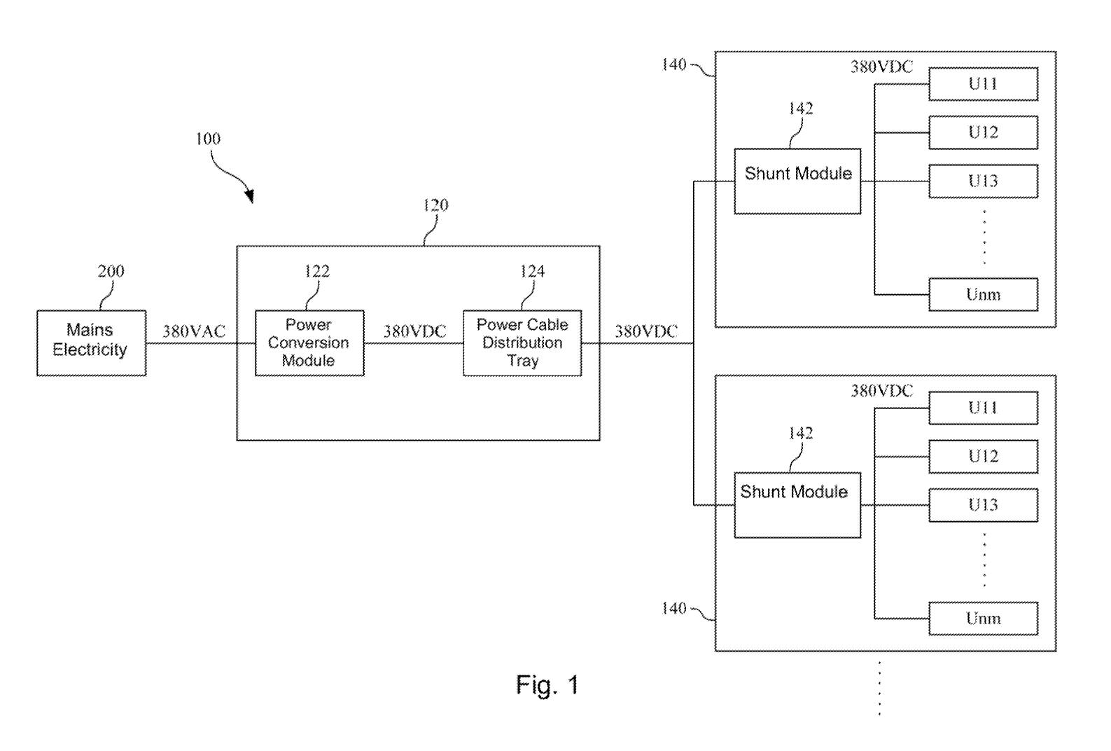

Referring to FIG. 1, FIG. 1 is a schematic view of an industrial computer set 100 according to an embodiment of the invention. As shown in FIG. 1, the industrial computer set 100 includes a power cabinet 120 and a plurality of system cabinets 140. In this embodiment, the power cabinet 120 can be used for supplying power to more than one group of system cabinets 140, but only two groups of system cabinets 140 are illustrated as an example for explanation, and thus the present invention is not limited to two groups. For example, in some embodiments, as a data center, the industrial computer set 100 may include twelve groups of system cabinets 140.

The power cabinet 120 is used as a main power supply source of the industrial computer set 100, and the power cabinet 120 may include a power conversion module 122 and a power cable distribution tray 124. The power conversion module 122 can be coupled with external mains electricity 200 (such as a mains socket or a mains switchboard). The mains electricity 200 is used for providing a group of high-voltage AC power inputs, wherein the high-voltage AC power is an AC power of more than 300V. For example, in this embodiment, the high-voltage AC power may be an AC power of 380V, and in an actual application, an electric power company itself can provide a three-phase AC power of 380V.

In this embodiment, the power conversion module 122 is coupled between the mains electricity 200 and the power cable distribution tray 124, and the power conversion module 122 is used for converting the high-voltage AC power into a high-voltage DC power. In this embodiment, the high-voltage DC power may be a DC power of 380V.

Each system cabinet 140 includes a plurality of system units U11-Unm and a shunt module 142. The shunt module 142 is coupled between the power cable distribution tray 124 and the system units U11-Unm. The shunt module 142 receives the high-voltage DC power (such as 380 VDC) from the power cable distribution tray 124 and shunts the high-voltage DC power to the system units U11-Unm.

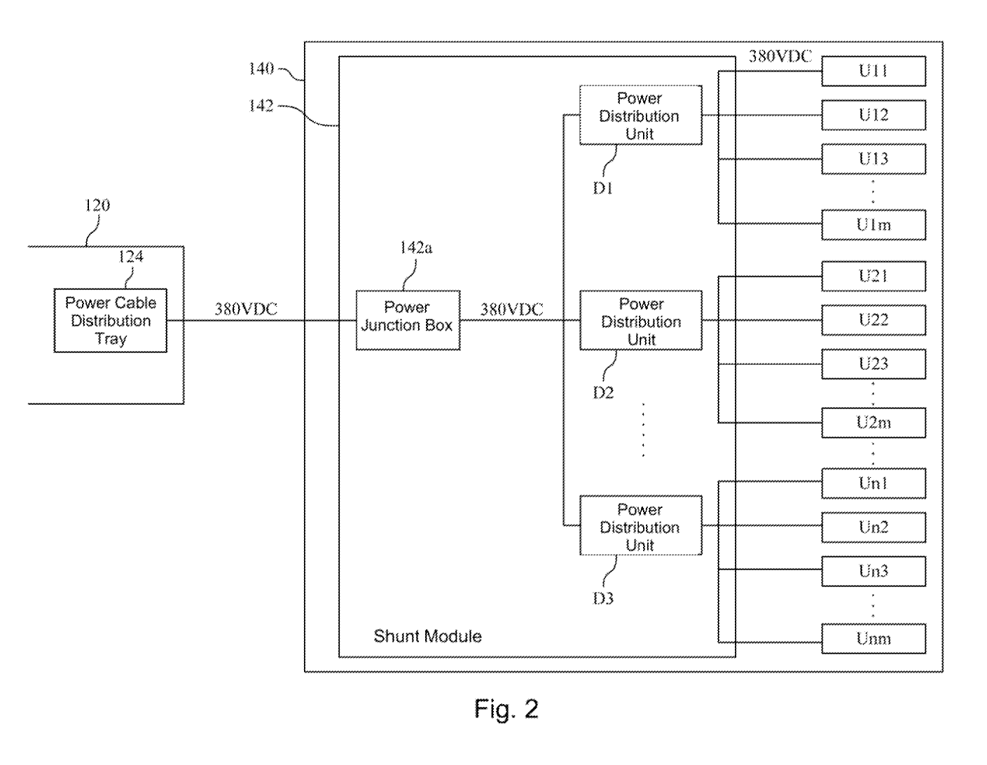

It should be especially noted that, in this embodiment, the shunt module 142 of the invention may further include a hierarchical structure through which the high-voltage DC power is shunted to the respective system units U11-Unm in a hierarchical manner. Referring to FIG. 2 additionally, FIG. 2 is a schematic view of the shunt module 142 in FIG. 1.

As shown in FIG. 2, the shunt module 142 includes a power junction box 142a and n pieces of power distribution units D1-Dn. Each system cabinet 140 includes n*m pieces of system units (i.e., includes U11-U1m, U21-U2m, . . . , Un1-Unm), wherein the power junction box 142a is coupled with the power cable distribution tray 124, and the power junction box 142a receives the high-voltage AC power (such as 380 VDC) from the power cable distribution tray 124 and shunts the high-voltage AC power to n pieces of power distribution units D1-Dn. Each of the power distribution units D1-Dn is used for shunting the high-voltage AC power (such as 380 VDC) to m pieces of system units. For example, the power distribution unit D1 corresponds to the system units U11-U1m, and the power distribution unit D2 corresponds to the system units U21-U2m, and so forth.

It should be noted that the aforementioned shunting manner of the shunt module 142 is merely used as an example for implementation of the invention, and the present invention is not limited to a specific hierarchical shunt manner or a specific number of the system units. In an actual application, the number of the system units depends on actual operation or server requirements. Each of the power distribution units D1-Dn can shunt the high-voltage AC power is (such as 380 VDC) to 1-m pieces of system units. Moreover, the number of the system units driven by each of the power distribution units D1-Dn may be different and may depend on the electrical loads of respective system units or other application factors.

In a practically large industrial computer set 100, each system cabinet 140 may include five to ten groups of power distribution units, and each power distribution unit corresponds to five to ten groups of system units. If no ordered cable distribution manner is adopted, the system cabinet 140 will be full of various messed circuit cables. The application of a power junction box 142a will help to putting the lines inside the system cabinet 140 in order.

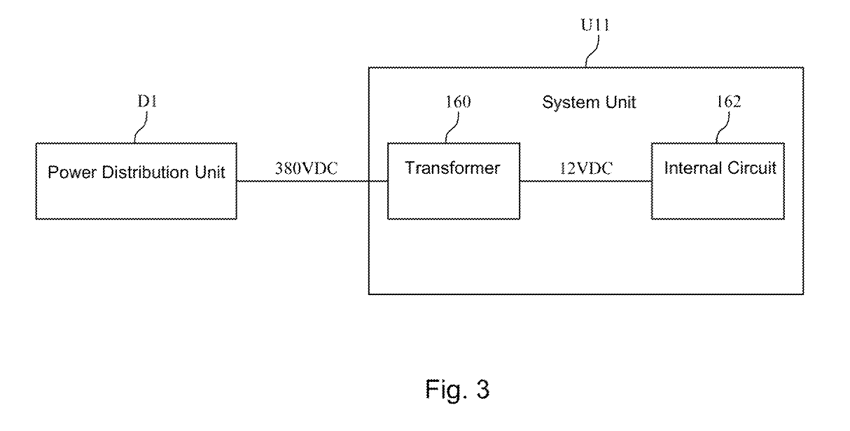

Referring to FIG. 3 additionally, FIG. 3 is an internal schematic view of the system unit U11 according to an embodiment of the invention. In FIG. 3, the system unit U11 is used as an example for explanation. In an actual application, the system units U11-Umn all have a similar structure.

As shown in FIG. 3, the system unit U11 includes a transformer 160 and an internal circuit 162. The transformer 160 is coupled with the power distribution unit D1 in the shunt module 142. The transformer 160 is used for converting the high-voltage DC power (such as 380 VDC) into a low-voltage DC power required by a general working circuit, e.g., a DC power of 12V (12 VDC), and the low-voltage DC power is used for driving the internal circuit 162. For example, the internal circuit 162 may include a processor, a system chip, a network module, a storage media, a display screen, etc.

It should be especially noted that, in the industrial computer set 100 of the present invention, the power cabinet 120 directly converts an input AC power source into a DC power source and directly distributes the power to the system units U11-Umn of each system cabinet 140 in the form of DC power source. It is different from a distribution manner in the form of AC power in the conventional art that the distribution manner in the form of DC power does not need to dispose AC-to-DC converters in the respective system units U11-Umn. Thus, if there are twelve groups of system cabinets, the cost of disposing 12*m*n AC-to-DC converters can then be saved. Moreover, the utilization of a DC power transmission architecture is convenient for disposing a power backup module.

To sum up, the present invention provides an industrial computer set, which has an independent power cabinet for supplying power to multiple system cabinets. Furthermore, the industrial computer set uses the power cabinet to directly convert a high-voltage AC power inputted from mains electricity into a high-voltage DC power and to transfer the high-voltage DC power respectively to each system cabinet. Each system cabinet only needs to divide or adjust a voltage of the DC power so as to transfer the DC power respectively to each system unit for use. Thus, the present invention helps to saving the cost of disposing respective AC-to-DC converters for the system units, and avoiding power resource waste and heat dissipation problem when multiple AC-to-DC converters operate concurrently.

Although the invention has been disclosed with reference to the above embodiments, these embodiments are not intended to limit the invention. It will be apparent to those skilled in the art that various modifications and variations can be made without departing from the scope or spirit of the invention. Therefore, the scope of the invention shall be defined by the appended claims.

What is claimed is:

1. An industrial computer set, comprising:
a power cabinet comprising a power conversion module and a power cable distribution tray, wherein the power conversion module is coupled between a mains electricity and the power cable distribution tray, and the power conversion module is used for converting a high-voltage AC power into a high-voltage DC power; and
a plurality of system cabinets, wherein each of the system cabinets comprises:
a plurality of system units; and
a shunt module coupled between the power cable distribution tray and the system units, wherein the shunt module is used for receiving the high-voltage DC power from the power cable distribution tray, and shunting the high-voltage DC power to the system units.

2. The industrial computer set of claim 1, wherein the shunt module comprises a power junction box and n pieces of power distribution units, and each of the system cabinets comprises n*m pieces of system units, wherein, the power junction box is used for shunting the high-voltage AC power to the power distribution units, and each of the power distribution units is used for shunting the high-voltage AC power to m pieces of system units.

3. The industrial computer set of claim 1, wherein each of the system units comprises a transformer and an internal circuit, wherein the transformer is coupled with the shunt module and the transformer is used for converting the high-voltage DC power into a low-voltage DC power for driving the internal circuit.

4. The industrial computer set of claim 1, wherein the mains electricity is used for provide the high-voltage AC power, and the high-voltage AC power is an AC power of more than 300V.

5. The industrial computer set of claim 1, wherein the high-voltage DC power is a DC power of more than 300V.

6. A power cabinet, used for being coupled to a plurality of system cabinets, wherein each of the system cabinets comprises a plurality of system units and a shunt module which is coupled to the system units, the power cabinet comprising:
a power conversion module which is coupled between a mains electricity and a power cable distribution tray and is used for converting a high-voltage AC power into a high-voltage DC power; and
a power cable distribution tray for shunting the high-voltage DC power to the shunt module in the system cabinets.

7. The power cabinet of claim 6, wherein the mains electricity is used for providing the high-voltage AC power, and the high-voltage AC power is an AC power of more than 300V.

8. The power cabinet of claim 6, wherein the high-voltage DC power is a DC power of more than 300V.

9. A system cabinet, coupled with a power cabinet, wherein the power cabinet comprises a power conversion module and a power cable distribution tray, and the power conversion module is coupled between a mains electricity and the power cable distribution tray and is used for converting a high-voltage AC power into a high-voltage DC power, and the power cable distribution tray transmits the high-voltage DC power to the system cabinet, the system cabinet comprising:
a plurality of system units, wherein each of the system units comprises an internal circuit and a transformer; and
a shunt module coupled between the power cable distribution tray and the system units for receiving the high-voltage DC power from the power cable distribution tray, and shunting the high-voltage DC power to the system units, wherein the transformer in each of the system units is coupled with the shunt module, and the transformer is used for converting the high-voltage DC power into a low-voltage DC power for driving the internal circuit.

10. The system cabinet of claim 9, wherein the shunt module comprises a power junction box and n pieces of power distribution units, and each of the system cabinets comprises n*m pieces of system units, wherein, the power junction box is used for shunting the high-voltage AC power to the power distribution units, and each of the power distribution units is used for shunting the high-voltage AC power to m pieces of system units.
